(19) United States
(12) Patent Application Publication
(10) Pub. No.: US 2022/0056251 A1
(43) Pub. Date: Feb. 24, 2022

(54) RUBBER COMPOSITION

(71) Applicant: COMPAGNIE GENERALE DES ETABLISSEMENTS MICHELIN, Clermont-Ferrand (FR)

(72) Inventors: José-Carlos ARAUJO DA SILVA, Clermont-Ferrand Cedex 9 (FR); Aurore CROCHET, Clermont-Ferrand Cedex 9 (FR); Guillaume HENNEBERT, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 17/414,578

(22) PCT Filed: Dec. 13, 2019
(86) PCT No.: PCT/FR2019/053053

§ 371 Date: Jun. 16, 2021

(30) Foreign Application Priority Data
Dec. 21, 2018 (FR) FR1873920

(51) Int. Cl. C08L 23/08; C08F 236/06; C08F 236/08; C08F 236/20; C08K 3/36; B60C 1/00

(52) U.S. Cl. CPC C08L 23/083; C08F 236/06; C08F 236/08; C08F 2810/40; C08K 3/36; B60C 1/0016; C08F 236/20

(57) ABSTRACT

The invention relates to a rubber composition which comprises an elastomer which is a copolymer of ethylene and of a 1,3-diene which comprises ethylene units which represent more than 50 mol % of the monomer units of the copolymer, the 1,3-diene being 1,3-butadiene or isoprene, 35 to 100 phr of a reinforcing filler which comprises a silica, a plasticizing system comprising a hydrocarbon plasticizing resin and a hydrocarbon liquid plasticizing agent, it being understood that the total content of hydrocarbon plasticizing resin and of hydrocarbon liquid plasticizing agent is greater than 10 phr and less than or equal to 80 phr. Such a composition confers on a tread of a tire an improved performance compromise between grip, roadholding and rolling resistance.

This application is a 371 national phase entry of PCT/FR2019/053053 filed on 13 Dec. 2019, which claims benefit of French Patent Application No. 1873920, filed 21 Dec. 2018, the entire contents of which are incorporated herein by reference for all purposes.

### BACKGROUND

### 1. Technical Field

The field of the present invention is that of reinforced rubber compositions which comprise a silica and a conjugated-diene/ethylene copolymer elastomer and which are intended for use in a tire, more particularly in the tread of a tire.

### 2. Related Art

In known manner, a tire comprises a crown extended by two sidewalls and two beads intended to come into contact with a rim, a carcass reinforcement anchored in the two beads, a crown reinforcement and a tread intended to come into contact with the ground.

A tire must comply with a large number of often contradictory technical requirements, including high wear resistance, low rolling resistance and high grip.

It has been possible to improve this performance compromise, in particular from the point of view of rolling resistance and wear resistance, by virtue in particular of the use as a tread of low-hysteresis rubber compositions having the characteristic of being reinforced predominately with highly dispersible silicas (HDSs), capable of rivalling, in terms of reinforcing power, conventional tire-grade carbon blacks.

It has also been possible to improve the performance compromise between rolling resistance and wear resistance of treads by introducing into a rubber composition a copolymer of ethylene and of 1,3-butadiene containing more than 50 mol % of ethylene units. Reference may be made, for example, to patent application WO 2014114607 A1. However, such a composition does not make it possible to give the tread optimum grip performance, in particular for a passenger vehicle.

It is known that the grip performance of a tire can be improved by increasing the contact area of the tread on the ground on which it is running. One solution consists in using a highly deformable tread, in particular a very soft rubber composition which constitutes the surface of the tread intended to come into contact with the running surface. The use of a very soft rubber composition, which is nevertheless favourable for grip, can lead to a deterioration in the handling of the tire.

It is known that a greater stiffness of the tread is desirable for improving handling, it being possible for this stiffening of the tread to be obtained for example by increasing the content of reinforcing filler in the constituent rubber compositions of these treads or by incorporating certain reinforcing resins into said constituent rubber compositions of these treads. However, generally, these solutions are not always satisfactory, because they can be accompanied by a deterioration of the rolling resistance.

To meet these two contradictory requirements, which are handling and grip, one solution also consists in creating a stiffness gradient by a phenomenon of accommodation of the rubber composition of the tread as described in patent applications WO 02/10269 and WO 2012084599. This accommodation phenomenon results in the ability of the rubber composition to become less stiff at the surface of the tread under the effect of the deformations undergone by the tread during the rolling of the tire. This decrease in stiffness at the surface of the tread does not occur or occurs very little inside the tread, which thus maintains a higher degree of stiffness than the surface of the tread.

These technical solutions for improving the grip performance, handling performance and rolling resistance performance have generally been described for highly unsaturated diene elastomers which are characterized by a molar content of diene much greater than 50%.

A rubber composition comprising a copolymer of ethylene and of 1,3-butadiene, the processability of which is improved by the introduction of 5 to 10 phr of a plasticizing resin, is described in patent application JP 2013-185048. Not only is the molar content of ethylene in the copolymer much less than 50%, but the grip performance is also not addressed.

For the use of conjugated diene copolymers containing molar contents of ethylene greater than 50% in rubber compositions for a tire tread, there is therefore an interest and a need to also improve the grip performance of the tread.

### SUMMARY

Continuing its efforts, the applicant has discovered that the combined use of a highly saturated diene elastomer and a specific plasticizing system in a rubber composition for a tire tread makes it possible to improve the grip performance of the tire. Particular embodiments of the invention even help to improve the performance compromise between grip and rolling resistance. Other particular embodiments of the invention also make it possible to improve the performance compromise between grip and handling.

Thus a first object of the invention is a rubber composition which comprises:
an elastomer which is a copolymer of ethylene and of a 1,3-diene which comprises ethylene units which represent more than 50 mol % of the monomer units of the copolymer, the 1,3-diene being 1,3-butadiene or isoprene,
35 to 100 parts by weight per hundred parts of elastomer, phr, of a reinforcing filler which comprises a silica,
a plasticizing system comprising a plasticizing hydrocarbon resin and a liquid hydrocarbon plasticizing agent, it being understood that the total content of hydrocarbon plasticizing resin and of liquid hydrocarbon plasticizing agent is greater than 10 phr and less than or equal to 80 phr.

Another subject of the invention is a tire comprising a crown extended by two sidewalls and two beads, a carcass reinforcement anchored in the two beads, a crown reinforcement and a tread radially outside said crown reinforcement, which tire comprises a rubber composition according to the invention in the tread.

### DETAILED DESCRIPTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b). The abbreviation “phr” means parts by weight per hundred parts by weight of elastomer (of the total of the elastomers if several elastomers are present).

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of the monomer units of the copolymer, that is to say on the basis of all of the monomer units of the elastomer.

The compounds mentioned in the description may be of fossil or biobased origin. In the latter case, they can result, partially or completely, from biomass or be obtained from renewable starting materials resulting from biomass. Elastomers, plasticizers, fillers and the like are notably concerned.

In what follows, the radial direction denotes a direction perpendicular to the axis of rotation of the tire. “Radially inside or, respectively, radially outside” means “closer to or, respectively, further away from the axis of rotation of the tire”. “Axially inside or, respectively, axially outside” means “closer to or, respectively, further away from the equatorial plane of the tire”, the equatorial plane of the tire being the plane passing through the middle of the rolling surface of the tire and perpendicular to the axis of rotation of the tire.

In general, a tire comprises two beads, intended to provide a mechanical connection between the tire and the rim on which it is mounted, a crown composed of at least one crown reinforcement and a tread, and extended by two sidewalls. The tread, intended to come into contact with the ground and connected by the two sidewalls, is radially outside said crown reinforcement. The tire also comprises a reinforcement anchored in the two beads, termed carcass reinforcement, which is radially inside said crown reinforcement.

The copolymer of ethylene and of 1,3-diene which is useful for the purposes of the invention is a preferably random elastomer which comprises ethylene units resulting from the polymerization of ethylene. In a known way, the expression “ethylene unit” refers to the —(CH₂—CH₂)— unit resulting from the insertion of ethylene into the elastomer chain. In the copolymer of ethylene and of 1,3-diene, the ethylene units represent more than 50 mol % of the monomer units of the copolymer. Preferably, the ethylene units in the copolymer represent more than 60 mol %, advantageously more than 70 mol % of the monomer units of the copolymer. According to any one of the embodiments of the invention, including the preferential variants thereof, the highly saturated diene elastomer preferentially comprises at most 90 mol % of ethylene unit.

The copolymer which is useful for the purposes of the invention, also referred to below as “highly saturated diene elastomer”, also comprises 1,3-diene units resulting from the polymerization of a 1,3-diene, the 1,3-diene being 1,3-butadiene or isoprene. In a known manner, the term “1,3-diene unit” refers to units resulting from the insertion of the 1,3-diene via a 1,4 addition, a 1,2 addition or a 3,4 addition in the case of isoprene. Preferably, the 1,3-diene is 1,3-butadiene.

According to a first embodiment of the invention, the copolymer of ethylene and of a 1,3-diene contains units of formula (I). The presence of a saturated 6-membered cyclic unit, 1,2-cyclohexanediyl, of formula (I) as a monomer unit in the copolymer can result from a series of very particular insertions of ethylene and 1,3-butadiene in the polymer chain during its growth.

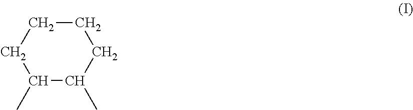

According to a second preferential embodiment of the invention, the copolymer of ethylene and of a 1,3-diene contains units of formula (II-1) or (II-2).

—CH₂—CH(CH═CH₂)— (II-1)

—CH₂—CH(CMe=CH₂) (II-2)

According to a third preferential embodiment of the invention, the copolymer of ethylene and of a 1,3-diene contains units of formula (I) and of formula (II-1).

According to a fourth embodiment of the invention, the highly saturated diene elastomer is devoid of units of formula (I). According to this fourth embodiment, the copolymer of ethylene and of a 1,3-diene preferably contains units of formula (II-1) or (II-2).

Preferably, the highly saturated diene elastomer contains units resulting from the insertion of the 1,3-diene by a 1,4 addition, that is to say units of formula —CH₂—CH═CH—CH₂— when the 1,3-diene is 1,3-butadiene, or of formula —CH₂—CMe=C—CH₂— when the 1,3-diene is isoprene.

When the highly saturated diene elastomer comprises units of formula (I) or units of formula (II-1) or else comprises units of formula (I) and units of formula (II-1), the molar percentages of the units of formula (I) and of the units of formula (II-1) in the highly saturated diene elastomer, respectively o and p, preferably satisfy the following equation (eq. 1), more preferentially satisfy the equation (eq. 2), o and p being calculated on the basis of all the monomer units of the highly saturated diene elastomer.

0<o+p≤25 (eq. 1)

0<o+p<20 (eq. 2)

According to the first embodiment, according to the second embodiment of the invention, according to the third embodiment and according to the fourth embodiment, including the preferential variants thereof, the highly saturated diene elastomer is preferentially a random copolymer.

The highly saturated diene elastomer, in particular according to the first embodiment, according to the second embodiment, according to the third embodiment and according to the fourth embodiment, can be obtained according to various synthesis methods known to a person skilled in the art, in particular as a function of the intended microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in documents EP 1 092 731, WO 2004035639, WO 2007054223 and WO 2007054224 in the name of the applicant. The highly saturated diene elastomer, including the case when it is random, may also be prepared via a process using a catalytic system of preformed type such as those described in documents WO 2017093654 A1, WO 2018020122 A1 and WO 2018020123 A1.

The highly saturated diene elastomer may consist of a mixture of copolymers of ethylene and of 1,3-diene which differ from each other by virtue of their microstructures or their macrostructures.

According to the first embodiment of the invention, according to the second embodiment of the invention, according to the third embodiment and according to the fourth embodiment, the highly saturated diene elastomer is preferably a copolymer of ethylene and of 1,3-butadiene, more preferentially a random copolymer of ethylene and of 1,3-butadiene.

According to one particular embodiment of the invention, the copolymer of ethylene and of a 1,3-diene bears at the chain end a functional group F¹ which is a silanol or alkoxysilane function. This embodiment is also favourable to improving the rolling resistance.

According to this embodiment, the silanol or alkoxysilane function is located at the end of the chain of the highly saturated diene elastomer. In the present application, the alkoxysilane or silanol function borne at one of the ends is referred to in the present application by the name the functional group F¹. Preferably, it is attached directly via a covalent bond to the terminal unit of the highly saturated diene elastomer, which means to say that the silicon atom of the function is directly bonded, covalently, to a carbon atom of the terminal unit of the highly saturated diene elastomer. The terminal unit to which the functional group F¹ is directly attached preferably consists of a methylene bonded to an ethylene unit or to a 1,2-cyclohexanediyl unit, of formula (I), the Si atom being bonded to the methylene. A terminal unit is understood to mean the last unit inserted in the copolymer chain by copolymerization, which unit is preceded by a penultimate unit, which is itself preceded by the antepenultimate unit.

According to a first variant of this embodiment, the functional group F¹ is of formula (III-a)

Si(OR¹)_{3-f}(R²)_{f} (III-a)

the R¹ symbols, which may be identical or different, representing an alkyl,

the R² symbols, which may be identical or different, representing a hydrogen atom, a hydrocarbon chain or a hydrocarbon chain substituted by a chemical function F²,

f being an integer ranging from 0 to 2.

In formula (III-a), the R¹ symbols are preferentially an alkyl having at most 6 carbon atoms, more preferentially a methyl or an ethyl, more preferentially still a methyl. If 3-f is greater than 1, the R¹ symbols are advantageously identical, in particular methyl or ethyl, more particularly methyl.

According to a second variant of this embodiment, the functional group F¹ is of formula (III-b)

Si(OH)(R²)₂ (III-b)

the R² symbols, which may be identical or different, representing a hydrogen atom, a hydrocarbon chain or a hydrocarbon chain substituted by a chemical function F².

Among the hydrocarbon chains represented by the R² symbols in formulae (III-a) and (III-b), mention may be made of alkyls, in particular those having 1 to 6 carbon atoms, preferentially methyl or ethyl, more preferentially methyl.

Among the hydrocarbon chains substituted by a chemical function F² represented by the R² symbols in formulae (III-a) and (III-b), mention may be made of alkanediyl chains, in particular those comprising at most 6 carbon atoms, very particularly the 1,3-propanediyl group, the alkanediyl group bearing a substituent, the chemical function F², in other words one valence of the alkanediyl chain for the function F², the other valence for the silicon atom of the silanol or alkoxysilane function.

In formulae (III-a) and (III-b), a chemical function F² is understood to mean a group which is different from a saturated hydrocarbon group and which may participate in chemical reactions. Among the chemical functions which may be suitable, mention may be made of the ether function, the thioether function, the primary, secondary or tertiary amine function, the thiol function, the silyl function. The primary or secondary amine or thiol functions may be protected or may not be protected. The protective group for the amine and thiol functions is for example a silyl group, in particular a trimethylsilyl or tert-butyldimethylsilyl group. Preferably, the chemical function F² is a primary, secondary or tertiary amine function or a thiol function, the primary or secondary amine or thiol function being protected by a protective group or being unprotected.

Preferably, the R² symbols, which may be identical or different, represent an alkyl having at most 6 carbon atoms or an alkanediyl chain having at most 6 carbon atoms and substituted by a chemical function F² in formulae (III-a) and (III-b).

Mention may be made, as functional group F1, of the dimethoxymethylsilyl, dimethoxyethylsilyl, diethoxymethysilyl, diethoxyethysilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl, 3-thiopropyldiethoxysilyl, methoxydimethylsilyl, methoxydiethylsilyl, ethoxydimethysilyl, ethoxydiethysilyl, 3-(N,N-dimethylamino)propylmethoxymethylsilyl, 3-(N,N-dimethylamino)propylmethoxyethylsilyl, 3-(N,N-dimethylamino)propylethoxymethylsilyl, 3-(N,N-dimethylamino)propylethoxyethylsilyl, 3-aminopropylmethoxymethylsilyl, 3-aminopropylmethoxyethylsilyl, 3-aminopropylethoxymethylsilyl, 3-aminopropylethoxyethylsilyl, 3-thiopropylmethoxymethylsilyl, 3-thiopropylethoxymethylsilyl, 3-thiopropylmethoxyethylsilyl and 3-thiopropylethoxyethylsilyl groups.

Mention may also be made, as functional group F¹, of the silanol form of the functional groups mentioned above which contain one and only one ethoxy or methoxy function, it being possible for the silanol form to be obtained by hydrolysis of the ethoxy or methoxy function. In this regard, the dimethylsilanol, diethylsilanol, 3-(N,N-dimethylamino)propylmethylsilanol, 3-(N,N-dimethylamino)propylethylsilanol, 3-aminopropylmethylsilanol, 3-aminopropylethylsilanol, 3-thiopropylethylsilanol and 3-thiopropylmethylsilanol groups are suitable.

Mention may also be made, as functional group F¹, of the functional groups whether they are in the alkoxy or silanol form, which have been mentioned above and which comprise an amine or thiol function in a form protected by a silyl group, in particular trimethylsilyl or tert-butyldimethylsilyl group.

Preferably, the functional group F¹ is of formula (III-a) in which f is equal to 1. For this preferential variant, the groups for which R¹ is a methyl or an ethyl, such as for example the dimethoxymethylsilyl, dimethoxyethylsilyl, diethoxymethysilyl, diethoxyethysilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl and 3-thiopropyldiethoxysilyl groups, are very particularly suitable. Also suitable are the protected forms of the amine or thiol function of the last 4 functional groups mentioned in the preceding list, protected by a silyl group, in particular a trimethylsilyl or tert-butyldimethylsilyl group.

More preferentially, the functional group F¹ is of formula (III-a) in which f is equal to 1 and R¹ is a methyl. For this more preferential variant, the dimethoxymethylsilyl, dimethoxyethylsilyl, 3-(N,N-dimethylamino)propyldimethoxysilyl, 3-aminopropyldimethoxysilyl and 3-thiopropyldimethoxysilyl groups, and also the protected forms of the amine or thiol function of 3-aminopropyldimethoxysilyl or 3-thiopropyldimethoxysilyl, protected by a trimethylsilyl or a tert-butyldimethylsilyl, are very particularly suitable.

The copolymer of ethylene and of a 1,3-diene which bears at the chain end a functional group F¹, silanol or alkoxysilane function, can be prepared by the process described in the patent application filed under number PCT/FR2018/051305 or in the patent application filed under number PCT/FR2018/051306, which process comprises steps (a) and (b), and, where appropriate, step (c) below:

(a) the copolymerization of a monomer mixture in the presence of a catalytic system comprising an organomagnesium compound and a metallocene,

(b) the reaction of a functionalizing agent with the polymer obtained in step a),

(c) where appropriate, a hydrolysis reaction.

Step a) is common to the copolymerization step carried out to prepare the non-functional homologous copolymers described above, with the only difference being that the copolymerization reaction is followed by a reaction for functionalization of the copolymer, step b).

Step b) consists in reacting a functionalizing agent with the copolymer obtained in step a) in order to functionalize the chain end of the copolymer. The functionalizing agent is a compound of formula (IV),

Si(Fc¹)_{4-g}(Rc²)_{g} (IV)

the Fc¹ symbols, which may be identical or different, representing an alkoxy group or a halogen atom,

the Rc² symbols, which may be identical or different, representing a hydrogen atom, a hydrocarbon chain or a hydrocarbon chain substituted by a chemical function Fc², g being an integer ranging from 0 to 2.

When the Fc¹ symbol represents an alkoxy group, the alkoxy group is preferably methoxy or ethoxy. When the Fc¹ symbol represents a halogen atom, the halogen atom is preferably chlorine.

The functionalizing agent can be of formula (IV-1), of formula (IV-2), of formula (IV-3) or of formula (IV-4),

MeOSi(Fc¹)_{3-g}(Rc²)_{g} (IV-1)

(MeO)₂Si(Fc¹)_{2-g}(Rc²)_{g} (IV-2)

(MeO)₃Si(Fc¹)_{1-g}(Rc²)_{g} (IV-3)

(MeO)₃SiRc² (IV-4),

in which the Fc¹ and Rc² symbols are as defined in formula (IV),

for formulae (IV-1) and (IV-2), g being an integer ranging from 0 to 2,

for formula (IV-3), g being an integer ranging from 0 to 1.

Among the hydrocarbon chains represented by the Rc² symbols in formulae (III), (IV-1), (IV-2), (IV-3) and (IV-4), mention may be made of alkyls, preferably alkyls having at most 6 carbon atoms, more preferentially methyl or ethyl, better still methyl.

Among the hydrocarbon chains substituted by a chemical function Fc² which are represented by the Rc² symbols in formulae (IV), (IV-1), (IV-2), (IV-3) and (IV-4), mention may be made of alkanediyl chains, preferably those comprising at most 6 carbon atoms, more preferentially the 1,3-propanediyl group, the alkanediyl group bearing a substituent, the chemical function Fc², in other words one valence of the alkanediyl chain for the function F², the other valence for the silicon atom of the silanol or alkoxysilane function.

In formulae (IV), (IV-1), (IV-2), (IV-3) and (IV-4), a chemical function is understood to mean a group which is different from a saturated hydrocarbon group and which may participate in chemical reactions. A person skilled in the art understands that the chemical function Fc² is a group that is chemically inert with respect to the chemical species present in the polymerization medium. The chemical function Fc² may be in a protected form, such as for example in the case of the primary amine, secondary amine or thiol function. Mention may be made, as chemical function Fc², of the ether, thioether, protected primary amine, protected secondary amine, tertiary amine, protected thiol, and silyl functions. Preferably, the chemical function Fc² is a protected primary amine function, a protected secondary amine function, a tertiary amine function or a protected thiol function. As protective groups for the primary amine, secondary amine and thiol functions, mention may be made of silyl groups, for example the trimethylsilyl and tert-butyldimethylsilyl groups.

g is preferably other than 0, which means that the functionalizing agent comprises at least one Si—Rc² bond.

Mention may be made, as functionalizing agent, of the compounds dimethoxydimethylsilane, diethoxydimethylsilane, dimethoxydiethylsilane, diethoxydiethylsilane, (N,N-dimethyl-3-aminopropyl)methyldimethoxysilane, (N,N-dimethyl-3-aminopropyl)methyldiethoxysilane, (N,N-dimethyl-3-aminopropyl)ethyldimethoxysilane, (N,N-dimethyl-3-aminopropyl)ethyldiethoxysilane, 3-methoxy-3,8,8,9,9-pentamethyl-2-oxa-7-thia-3,8-disiladecane, trimethoxymethylsilane, triethoxymethylsilane, trimethoxyethylsilane, triethoxyethylsilane, (N,N-dimethylaminopropyl)trimethoxysilane, (N,N-dimethylaminopropyl)triethoxysilane, (N-(3-trimethoxysilyl)propyl)-N-(trimethylsilyl)silanamine, (N-(3-triethoxysilyl)propyl)-N-(trimethylsilyl)silanamine and 3,3-dimethoxy-8,8,9,9-tetramethyl-2-oxa-7-thia-3,8-disiladecane, preferably dimethoxydimethylsilane, dimethoxydiethylsilane, (N,N-dimethyl-3-aminopropyl)methyldimethoxysilane, (N,N-dimethyl-3-aminopropyl)ethyldimethoxysilane, 3-methoxy-3,8,8,9,9-pentamethyl-2-oxa-7-thia-3,8-disiladecanetrimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane, more preferentially trimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane.

The functionalizing agent is typically added to the polymerization medium resulting from step a). It is typically added to the polymerization medium at a degree of conversion of the monomers selected by a person skilled in the art depending on the desired macrostructure of the elastomer. Since step a) is generally carried out under ethylene pressure, a degassing of the polymerization reactor may be carried out before the addition of the functionalizing agent. The functionalizing agent is added under inert and anhydrous conditions to the polymerization medium, maintained at the polymerization temperature. Use is typically made of from 0.25 to 10 mol of functionalizing agent per 1 mol of cocatalyst, preferably of from 2 to 4 mol of functionalizing agent per 1 mol of cocatalyst.

The functionalizing agent is brought into contact with the polymerization medium for a time sufficient to enable the functionalization reaction. This contact time is judiciously selected by a person skilled in the art as a function of the concentration of the reaction medium and of the temperature of the reaction medium. Typically, the functionalization reaction is carried out under stirring, at a temperature ranging from 17° C. to 80° C., for 0.01 to 24 hours.

Once functionalized, the elastomer may be recovered, in particular by isolating it from the reaction medium. The techniques for separating the elastomer from the reaction medium are well known to a person skilled in the art and are selected by a person skilled in the art depending on the amount of elastomer to be separated, its macrostructure and the tools available to a person skilled in the art. Mention may be made, for example, of the techniques of coagulating the elastomer in a solvent such as methanol, the techniques of evaporating the solvent of the reaction medium and the residual monomers, for example under reduced pressure.

When the functionalizing agent is of formula (IV), (IV-1) or (IV-2) and g is equal to 2, step b) may be followed by a hydrolysis reaction in order to form an elastomer bearing a silanol function at the chain end. The hydrolysis may be carried out by a step of stripping of the solution containing the elastomer at the end of step b), in a manner known to a person skilled in the art.

When the functionalizing agent is of formula (IV), (IV-1), (IV-2), (IV-3) or (IV-4), when g is other than 0 and when Rc² represents a hydrocarbon chain substituted by a function Fc² in a protected form, step b) may also be followed by a hydrolysis reaction in order to deprotect the function at the end of the chain of the elastomer. The hydrolysis reaction, step of deprotecting the function, is generally carried out in an acid or basic medium depending on the chemical nature of the function to be deprotected. For example, a silyl group, in particular trimethylsilyl or tert-butyldimethylsilyl group, which protects an amine or thiol function may be hydrolysed in an acid or basic medium in a manner known to a person skilled in the art. The choice of the deprotection conditions is judiciously made by a person skilled in the art taking into account the chemical structure of the substrate to be deprotected.

Step c) is an optional step depending on whether or not it is desired to convert the functional group into a silanol function or whether or not it is desired to deprotect the protected function. Preferentially, step c) is carried out before separating the elastomer from the reaction medium at the end of step b) or else at the same time as this separation step.

Whether or not it bears a silanol or alkoxysilane function, the content of the copolymer of ethylene and of a 1,3-diene is preferentially greater than 50 phr, more preferentially greater than 80 phr. The remainder to 100 phr can be any diene elastomer, for example a 1,3-butadiene homopolymer or copolymer or else an isoprene homopolymer or copolymer. According to any one of the embodiments of the invention, the content of the copolymer of ethylene and of a 1,3-diene is advantageously 100 phr. A high content of the copolymer in the rubber composition is even more favourable for the performance compromise between rolling resistance and grip.

The rubber composition in accordance with the invention also has the essential characteristic of comprising a reinforcing filler comprising a silica.

A reinforcing filler typically consists of nanoparticles of which the mean (weight-average) size is less than a micrometre, generally less than 500 nm, usually between 20 and 200 nm, in particular and more preferentially between 20 and 150 nm.

The content of reinforcing filler in the rubber composition is greater than or equal to 35 phr and less than or equal to 100 phr, preferably greater than or equal to 50 phr and less than or equal to 100 phr. Preferably, the silica represents more than 50% by weight of the reinforcing filler. More preferentially, the silica represents more than 85% by weight of the reinforcing filler.

The silica used can be any reinforcing silica known to a person skilled in the art, in particular any precipitated or fumed silica exhibiting a BET specific surface and a CTAB specific surface both of less than 450 m²/g, preferably within a range extending from 30 to 400 m²/g, in particular from 60 to 300 m²/g. In the present disclosure, the BET specific surface area is determined by gas adsorption using the Brunauer-Emmett-Teller method described in “The Journal of the American Chemical Society”, (Vol. 60, page 309, February 1938), and more specifically according to a method derived from Standard NF ISO 5794-1, appendix E, of June 2010 [multipoint (5 point) volumetric method—gas: nitrogen—degassing under vacuum: one hour at 160° C.—relative pressure p/po range: 0.05 to 0.17].

The CTAB specific surface area values were determined according to Standard NF ISO 5794-1, Appendix G of June 2010. The process is based on the adsorption of CTAB (N-hexadecyl-N,N,N-trimethylammonium bromide) on the “external” surface of the reinforcing filler.

Any type of precipitated silica, in particular highly dispersible precipitated silicas (referred to as “HDS” for “highly dispersible” or “highly dispersible silica”), can be used. These precipitated silicas, which may or may not be highly dispersible, are well known to a person skilled in the art. Mention may be made, for example, of the silicas described in applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The reinforcing filler may comprise any type of “reinforcing” filler other than silica, known for its capacity to reinforce a rubber composition which can be used in particular for the manufacture of tires, for example a carbon black. All carbon blacks, in particular the blacks conventionally used in tires or their treads, are suitable as carbon blacks. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used.

Preferably, the carbon black is used at a content of less than or equal to 20 phr, more preferentially less than or equal to 10 phr (for example the carbon black content may be in a range extending from 0.5 to 20 phr, in particular extending from 1 to 10 phr). Advantageously, the carbon black content in the rubber composition is less than or equal to 5 phr. Within the intervals indicated, the colouring properties (black pigmenting agent) and UV-stabilizing properties of the carbon blacks are beneficial, without, moreover, adversely affecting the typical performance qualities contributed by the silica.

To couple the reinforcing inorganic filler, in this case silica, to the elastomer, it is possible to use, in a well-known manner, an at least bifunctional coupling agent (or bonding agent) intended to ensure a sufficient connection, of chemical and/or physical nature, between the inorganic filler (surface of its particles) and the elastomer, in which case the rubber composition comprises a coupling agent for binding the silica to the elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the elastomer.

Use is in particular made of silane polysulfides, referred to as “symmetrical” or “asymmetrical” depending on their specific structure, as described, for example, in applications WO03/002648-A1 (or US2005/016651-A1) and WO03/002649-A1 (or US2005/016650-A1). Suitable in particular, without the definition below being limiting, are silane polysulfides corresponding to general formula (V) below:

Z-A-Sₓ-A-Z (V),

in which:
x is an integer from 2 to 8 (preferably from 2 to 5);
the A symbols, which may be identical or different, represent a divalent hydrocarbon radical (preferably a C₁-C₁₈ alkylene group or a C₆-C₁₂arylene group, more particularly a C₁-C₁₀ alkylene, in particular a C₁-C₄ alkylene, in particular propylene);
the Z symbols, which may be identical or different, correspond to one of the three formulae below:

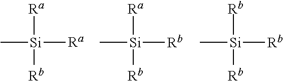

in which:
the R^{a} radicals, which are substituted or unsubstituted and identical to or different from one another, represent a C₁-C₁₈ alkyl group, a C₅-C₁₈ cycloalkyl group or a C₆-C₁₈ aryl group (preferably C₁-C₆ alkyl groups, cyclohexyl or phenyl, in particular C₁-C₄ alkyl groups, more particularly methyl and/or ethyl);
the R^{b} radicals, which may be substituted or unsubstituted and identical to or different from each other, represent a C₁-C₁₈ alkoxyl group or a C₅-C₁₈ cycloalkoxyl group (preferably a group selected from C₁-C₈ alkoxyls and C₅-C₈ cycloalkoxyls, even more preferentially a group selected from C₁-C₄ alkoxyls, in particular methoxyl and ethoxyl), or a hydroxyl group, or such that 2 R^{b} radicals represent a C₃-C₁₈ dialkoxyl group.

In the case of a mixture of alkoxysilane polysulfides corresponding to the above formula (V), in particular normal commercially available mixtures, the mean value of the “x” indices is a fractional number preferably within a range extending from 2 to 5, more preferentially of approximately 4.

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂ sold under the name Si69 by Evonik or bis(triethoxysilylpropyl) disulfide, abbreviated to TESPD, of formula [(C₂H₅O)₃Si(CH₂)₃S]₂ sold under the name Si75 by Evonik. Mention will also be made, as preferred examples, of bis(mono(C₁-C₄)alkoxyldi(C₁-C₄)alkylsilylpropyl) polysulfides (in particular disulfides, trisulfides or tetrasulfides), more particularly of bis(monoethoxydimethylsilylpropyl) tetrasulfide, such as described in the abovementioned patent application WO02/083782-A1 (or U.S. Pat. No. 7,217,751-B2).

Of course, use might also be made of mixtures of the coupling agents described above.

The content of coupling agent in the composition of the invention is advantageously less than or equal to 25 phr, it being understood that it is generally desirable to use as little as possible of it. Typically, the content of coupling agent represents from 0.5% to 15% by weight, with respect to the amount of reinforcing inorganic filler. Its content is preferably within a range extending from 0.5 to 20 phr, more preferentially within a range extending from 3 to 15 phr. This content is easily adjusted by a person skilled in the art according to the content of reinforcing inorganic filler used in the composition of the invention.

Another essential characteristic of the rubber composition of the tread of the tire in accordance with the invention is that it comprises a specific plasticizing system comprising a plasticizing hydrocarbon resin and a hydrocarbon liquid plasticizing agent, it being understood that the total content of hydrocarbon plasticizing resin and of hydrocarbon liquid plasticizing agent is greater than 10 phr and less than or equal to 80 phr, preferably greater than or equal to 30 phr and less than or equal to 80 phr.

Hydrocarbon resins, also known as hydrocarbon plasticizing resins, are polymers well known to a person skilled in the art, essentially based on carbon and hydrogen but which can comprise other types of atoms, for example oxygen, which can be used in particular as plasticizing agents or tackifying agents in polymer matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, VCH, 1997, ISBN 3-527-28617-9), Chapter 5 of which is devoted to their applications, notably in the tire rubber field (5.5. “Rubber Tires and Mechanical Goods”). In a known way, these hydrocarbon resins can also be described as thermoplastic resins in the sense that they soften when heated and can thus be moulded. The softening point of the hydrocarbon resins is measured according to Standard ISO 4625 (“Ring and Ball” method). The Tg is measured according to Standard ASTM D3418 (1999). The macrostructure (Mw, Mn and PDI) of the hydrocarbon resin is determined by size exclusion chromatography (SEC); solvent tetrahydrofuran; temperature 35° C.; concentration 1 g/I; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

The hydrocarbon resins may be aliphatic or aromatic or else of the aliphatic/aromatic type, that is to say based on aliphatic and/or aromatic monomers. They can be natural or synthetic and may or may not be petroleum-based (if such is the case, they are also known under the name of petroleum resins). Preferably, the hydrocarbon plasticizing resin has a glass transition temperature above 20° C.

Advantageously, the hydrocarbon plasticizing resin has at least any one of the following features, more preferentially all of them:
a Tg above 30° C.;
a number-average molecular weight (Mn) of between 300 and 2000 g/mol, more preferentially between 400 and 1500 g/mol;
a polydispersity index (PI) of less than 3, more preferentially of less than 2 (as a reminder: PI=Mw/Mn with Mw the weight-average molecular weight).

Preferably, the hydrocarbon plasticizing resin is selected from the group consisting of cyclopentadiene homopolymer resins, cyclopentadiene copolymer resins, dicyclopentadiene homopolymer resins, dicyclopentadiene copolymer resins, terpene homopolymer resins, terpene copolymer resins, C5-cut homopolymer resins, C5-cut copolymer resins, C9-cut homopolymer resins, C9-cut copolymer resins, hydrogenated cyclopentadiene homopolymer resins and hydrogenated cyclopentadiene copolymer resins.

More preferentially, the hydrocarbon plasticizing resin is a C9-cut copolymer resin or a dicyclopentadiene copolymer resin, which is hydrogenated or non-hydrogenated. By way of example, mention may very particularly be made of C9-cut copolymer resins and hydrogenated dicyclopentadiene copolymer resins.

Hydrocarbon liquid plasticizing agents are known to soften a rubber composition by diluting the elastomer and the reinforcing filler of the rubber composition. Their Tg is typically less than −20° C., preferentially less than −40° C. Any hydrocarbon extender oil or any hydrocarbon liquid plasticizing agent known for its plasticizing properties with respect to diene elastomers can be used. At ambient temperature (23° C.), these plasticizers or these oils, which are more or less viscous, are liquids (that is to say, as a reminder, substances which have the ability to eventually take on the shape of their container), as opposed especially to hydrocarbon plasticizing resins which are by nature solid at ambient temperature.

As hydrocarbon liquid plasticizing agents, mention may be made of liquid diene polymers, polyolefin oils, naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, and mixtures of these compounds.

Preferably, the hydrocarbon liquid placticizing agent is selected from the group consisting of liquid diene polymers, aliphatic polyolefin oils, paraffinic oils, MES oils, TDAE oils, TRAE oils, SRAE oils, mineral oils and mixtures thereof. More preferentially, the hydrocarbon liquid plasticizing agent is a liquid diene polymer, an aliphatic polyolefin oil, a paraffinic oil, an MES oil or mixtures thereof.

According to one particular embodiment of the invention, the weight ratio between the content of hydrocarbon plasticizing resin and the total content of hydrocarbon plasticizing resin and of hydrocarbon liquid plasticizing agent is greater than 0.4, the contents being expressed in phr. This particular embodiment is also favourable to improving the handling of a tire, the tread of which comprises such a rubber composition.

The plasticizing system may contain, generally in a small amount, another plasticizing agent other than the hydrocarbon plasticizing resin and the hydrocarbon liquid plasticizing agent useful for the needs of the invention, as long as the desired performance compromise is not detrimentally modified. This other plasticizing agent can be, for example, a processing aid traditionally used in a small amount to promote, for example, the dispersion of the silica. According to any one of the embodiments of the invention, the hydrocarbon plasticizing resin and the hydrocarbon liquid plasticizing agent advantageously represent substantially the main part of the plasticizing system, that is to say the ratio between the content of hydrocarbon plasticizing resin and of hydrocarbon liquid plasticizing agent to the content of the total plasticizing system in the rubber composition, the contents being expressed in phr, is advantageously greater than 0.8, very advantageously greater than 0.9.

According to a first variant of the invention, the weight ratio between the content of reinforcing filler and the total content of hydrocarbon plasticizing resin and of hydrocarbon liquid plasticizing agent is less than 1.2, the contents being expressed in phr. The rubber composition according to the first variant is most particularly suitable for use in the form of a constituent layer of a tread of a tire, which layer is intended to come into contact with the running surface, when the tire is new. According to this particular embodiment of the first variant, the surface, of the tread, in contact with the ground proves to be highly deformable, which is additionally favourable to the improvement of the grip performance by increasing the area of contact of the tread on the ground during running.

According to a second variant of the invention, the weight ratio between the content of reinforcing filler and the total content of hydrocarbon plasticizing resin and of hydrocarbon liquid plasticizing agent is greater than or equal to 1.2, the contents being expressed in phr. The rubber composition according to the second variant most particularly lends itself to being used in the form of a constituent layer of a tread, which layer, termed inner layer of the tread, is radially inside a layer which is also a constituent layer of the tread and which is intended to come into contact with the ground when the tire is new. The inner layer of the tread according to this particular embodiment of the second variant provides stiffening within the tread, which is also favourable to the improvement in the roadholding of a tire, the tread of which has a high-grip surface due to the use of a very soft rubber composition and intended to come into contact with the ground.

The rubber composition in accordance with the invention can also comprise all or some of the usual additives customarily used in elastomer compositions intended for the manufacture of tires, in particular pigments, protective agents such as anti-ozone waxes, chemical anti-ozonants, antioxidants, a crosslinking system which can be based either on sulfur or on sulfur donors and/or on peroxide and/or on bismaleimides, vulcanization accelerators or retarders, or vulcanization activators.

The actual crosslinking system is preferentially a vulcanization system, that is to say based on sulfur and on a primary vulcanization accelerator. The sulfur is typically provided in the form of molecular sulfur or of a sulfur-donating agent, preferably in molecular form. Sulfur in molecular form is also referred to by the term “molecular sulfur”. The term “sulfur donor” means any compound which releases sulfur atoms, optionally combined in the form of a polysulfide chain, which are capable of inserting into the polysulfide chains formed during the vulcanization and bridging the elastomer chains. Various known secondary vulcanization accelerators or vulcanization activators, such as zinc oxide, stearic acid, guanidine derivatives (in particular diphenylguanidine), and the like, are added to the vulcanization system, being incorporated during the first non-productive phase and/or during the productive phase. The sulfur content is preferably between 0.5 and 3.0 phr and the content of the primary accelerator is preferably between 0.5 and 5.0 phr. These preferential contents may apply to any one of the embodiments of the invention.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators. As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide. As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

The crosslinking (or curing), where appropriate the vulcanization, is carried out in a known manner at a temperature generally of between 130° C. and 200° C., for a sufficient time which may vary, for example, between 5 and 90 min, depending especially on the curing temperature, on the crosslinking system adopted and on the crosslinking kinetics of the composition in question.

The rubber composition, before crosslinking, may be manufactured in appropriate mixers, using two successive phases of preparation according to a general procedure well known to a person skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first (non-productive) phase is carried out in a single thermomechanical step during which all the necessary constituents, the optional additional processing agents and various other additives, with the exception of the crosslinking system, are introduced into an appropriate mixer, such as a normal internal mixer. The total duration of the kneading, in this non-productive phase, is preferably between 1 and 15 min. After cooling the mixture thus obtained during the first non-productive phase, the crosslinking system is then incorporated at low temperature, generally in an external mixer, such as an open mill; everything is then mixed (productive phase) for a few minutes, for example between 2 and 15 min.

The rubber composition can be calendered or extruded in the form of a sheet or of a slab, in particular for a laboratory characterization, or also in the form of a rubber semi-finished product (or profiled element) which can be used in a tire. The composition may be either in the raw state (before crosslinking or vulcanization) or in the cured state (after crosslinking or vulcanization), may be a semi-finished product which can be used in a tire.

The tire, which is another subject of the invention, which comprises a rubber composition in accordance with the invention, preferably comprises the rubber composition in the tread.

When the weight ratio between the content of reinforcing filler and the total content of hydrocarbon plasticizing resin and of hydrocarbon liquid plasticizing agent is less than 1.2, the tire comprises the rubber composition preferentially in a constituent layer of the tread, which layer is intended to come into contact with the running surface, when the tire is new.

When the weight ratio between the content of reinforcing filler and the total content of hydrocarbon plasticizing resin and of hydrocarbon liquid plasticizing agent is greater than or equal to 1.2, the tire comprises the rubber composition preferentially in a constituent layer of the tread, which layer, termed layer radially inside the tread, is radially inside a layer which is also a constituent layer of the tread and which is intended to come into contact with the ground when the tire is new. The layer termed layer radially inside the tread can also be intended to come into contact with the ground gradually as the tread wears.

In summary, the invention is advantageously implemented according to any one of the following embodiments 1 to 40:

Embodiment 1: Rubber composition which comprises:
an elastomer which is a copolymer of ethylene and of a 1,3-diene which comprises ethylene units which represent more than 50 mol % of the monomer units of the copolymer, the 1,3-diene being 1,3-butadiene or isoprene,
35 to 100 phr of a reinforcing filler which comprises a silica,
a plasticizing system comprising a plasticizing hydrocarbon resin and a liquid hydrocarbon plasticizing agent, it being understood that the total content of hydrocarbon plasticizing resin and of liquid hydrocarbon plasticizing agent is greater than 10 phr and less than or equal to 80 phr.

Embodiment 2: Rubber composition according to embodiment 1, in which the ethylene units in the copolymer represent more than 60 mol % of the monomer units of the copolymer.

Embodiment 3: Rubber composition according to embodiment 1 or embodiment 2, in which the ethylene units in the copolymer represent more than 70 mol % of the monomer units of the copolymer.

Embodiment 4: Rubber composition according to any one of embodiments 1 to 3, in which the copolymer comprises at most 90 mol % of ethylene units.

Embodiment 5: Rubber composition according to any one of embodiments 1 to 4, in which the 1,3-diene is 1,3-butadiene.

Embodiment 6: Rubber composition according to any one of embodiments 1 to 5, in which the copolymer contains units of formula (I).

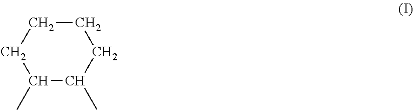

Embodiment 7: Rubber composition according to any one of embodiments 1 to 6, in which the copolymer contains units of formula (II-1) or (II-2).

—CH₂—CH(CH═CH₂)— (II-1)

—CH₂—CH(CMe=CH₂) (II-2)

Embodiment 8: Rubber composition according to any one of embodiments 1 to 7, in which the copolymer contains units of formula (I) and of formula (II-1).

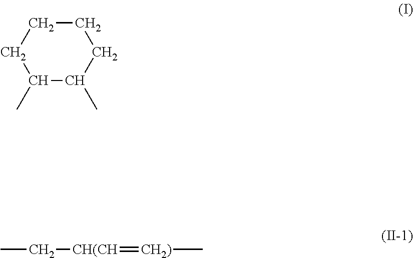

Embodiment 9: Rubber composition according to any one of embodiments 1 to 8, in which the copolymer contains units of formula —CH₂—CH═CH—CH₂— when the 1,3-diene is 1,3-butadiene, or of formula —CH₂—CMe=C—CH₂— when the 1,3-diene is isoprene.

Embodiment 10: Rubber composition according to any one of embodiments 1 to 9, in which the molar percentages of the units of formula (I) and of the units of formula (II-1) in the copolymer, respectively o and p, satisfy the following equation (eq. 1), o and p being calculated on the basis of all the monomer units of the copolymer.

0<o+p≤25 (eq. 1)

Embodiment 11: Rubber composition according to any one of embodiments 1 to 10, in which the molar percentages of the units of formula (I) and of the units of formula (II-1) in the copolymer, respectively o and p, satisfy the following equation (eq. 2), o and p being calculated on the basis of all the monomer units of the copolymer.

0<o+p<20 (eq. 2)

Embodiment 12: Rubber composition according to any one of embodiments 1 to 11, in which the copolymer is a random copolymer.

Embodiment 13: Rubber composition according to any one of embodiments 1 to 12, in which the copolymer of ethylene and of a 1,3-diene bears at the chain end a functional group F¹ which is a silanol or alkoxysilane function.

Embodiment 14: Rubber composition according to embodiment 13, in which the alkoxysilane or silanol function is directly attached by covalent bonding to the terminal unit of the highly saturated diene elastomer.

Embodiment 15: Rubber composition according to embodiment 13 or 14, in which the functional group F¹ is of formula (III-a)

Si(OR¹)_{3-f}(R²)_{f} (III-a)

the R¹ symbols, which may be identical or different, representing an alkyl,

the R² symbols, which may be identical or different, representing a hydrogen atom, a hydrocarbon chain or a hydrocarbon chain substituted by a chemical function F²,

f being an integer ranging from 0 to 2.

Embodiment 16: Rubber composition according to embodiment 13 or 14, in which the functional group F¹ is of formula (III-b)

Si(OH)(R²)₂, (III-b)

the R² symbols, which may be identical or different, representing a hydrogen atom, a hydrocarbon chain or a hydrocarbon chain substituted by a chemical function F².

Embodiment 17: Rubber composition according to embodiment 16, in which the chemical function F² is a primary, secondary or tertiary amine function or a thiol function, the primary or secondary amine or thiol function being protected by a protective group or being unprotected.

Embodiment 18: Rubber composition according to any one of embodiments 15 to 17, in which the symbols R¹ are a methyl or an ethyl, and the symbols R² are a methyl or an ethyl or propanediyl bearing the chemical function F².

Embodiment 19: Rubber composition according to any one of embodiments 1 to 18, in which the content of the copolymer of ethylene and of a 1,3-diene is greater than 50 phr.

Embodiment 20: Rubber composition according to any one of embodiments 1 to 19, in which the content of the copolymer of ethylene and of a 1,3-diene is greater than 80 phr.

Embodiment 21: Rubber composition according to any one of embodiments 1 to 20, in which the silica represents more than 50% by weight of the reinforcing filler.

Embodiment 22: Rubber composition according to any one of embodiments 1 to 21, in which the silica represents more than 85% by weight of the reinforcing filler.

Embodiment 23: Rubber composition according to any one of embodiments 1 to 22, which rubber composition comprises a coupling agent.

Embodiment 24: Rubber composition according to any one of embodiments 1 to 23, in which the content of reinforcing filler is greater than or equal to 50 phr and less than or equal to 100 phr.

Embodiment 25: Rubber composition according to any one of embodiments 1 to 24, in which the content of carbon black is less than or equal to 10 phr.

Embodiment 26: Rubber composition according to embodiment 25, in which the content of carbon black is less than or equal to 5 phr.

Embodiment 27: Rubber composition according to any one of embodiments 1 to 26, in which the total content of hydrocarbon plasticizing resin and of hydrocarbon liquid plasticizing agent is greater than or equal to 30 phr and less than or equal to 80 phr.

Embodiment 28: Rubber composition according to any one of embodiments 1 to 27, in which the hydrocarbon plasticizing resin has a glass transition temperature of greater than 20° C.

Embodiment 29: Rubber composition according to any one of embodiments 1 to 28, in which the hydrocarbon plasticizing resin is selected from the group consisting of cyclopentadiene homopolymer resins, cyclopentadiene copolymer resins, dicyclopentadiene homopolymer resins, dicyclopentadiene copolymer resins, terpene homopolymer resins, terpene copolymer resins, C5-cut homopolymer resins, C5-cut copolymer resins, C9-cut homopolymer resins, C9-cut copolymer resins, hydrogenated cyclopentadiene homopolymer resins and hydrogenated cyclopentadiene copolymer resins.

Embodiment 30: Rubber composition according to any one of embodiments 1 to 29, in which the hydrocarbon plasticizing resin is a C9-cut copolymer resin or a dicyclopentadiene copolymer resin, which is hydrogenated or non-hydrogenated, for example a hydrogenated C9-cut and dicyclopentadiene copolymer resin.

Embodiment 31: Rubber composition according to any one of embodiments 1 to 30, in which the hydrocarbon liquid plasticizing agent is selected from the group consisting of liquid diene polymers, aliphatic polyolefin oils, paraffinic oils, MES oils, TDAE oils, TRAE oils, SRAE oils, mineral oils and mixtures thereof.

Embodiment 32: Rubber composition according to any one of embodiments 1 to 31, in which the hydrocarbon liquid plasticizing agent is a liquid diene polymer, an aliphatic polyolefin oil, a paraffinic oil, an MES oil or mixtures thereof.

Embodiment 33: Rubber composition according to any one of embodiments 1 to 33, in which the weight ratio between the content of hydrocarbon plasticizing resin and the total content of hydrocarbon plasticizing resin and of hydrocarbon liquid plasticizing agent is greater than 0.4.

Embodiment 34: Rubber composition according to any one of embodiments 1 to 3, in which the rubber composition comprises a crosslinking system.

Embodiment 35: Rubber composition according to embodiment 34, in which the crosslinking system is a vulcanization system.

Embodiment 36: Rubber composition according to any one of embodiments 1 to 35, in which the weight ratio between the content of reinforcing filler and the total content of hydrocarbon plasticizing resin and of hydrocarbon liquid plasticizing agent is less than 1.2.

Embodiment 37: Rubber composition according to any one of embodiments 1 to 36, in which the weight ratio between the content of reinforcing filler and the total content of hydrocarbon plasticizing resin and of hydrocarbon liquid plasticizing agent is greater than or equal to 1.2.

Embodiment 38: Tire comprising a crown extended by two sidewalls and two beads, a carcass reinforcement anchored in the two beads, a crown reinforcement and a tread radially outside said crown reinforcement, which tire comprises a rubber composition defined in any one of embodiments 1 to 37 in the tread.

Embodiment 39: Tire according to embodiment 38 and according to embodiment 36, which tire comprises the rubber composition in a constituent layer of the tread, which layer is intended to come into contact with the running surface, when the tire is new.

Embodiment 40: Tire according to embodiment 38 and according to embodiment 37, which tire comprises the rubber composition in a constituent layer of the tread, which layer is radially inside a layer which is also a constituent layer of the tread and which is intended to come into contact with the ground when the tire is new.

The abovementioned characteristics of the present invention, and also others, will be understood more clearly on reading the following description of several implementation examples of the invention, which are given as non-limiting illustrations.

### EXAMPLE

II.1 Tests and Measurements:

II.1-1 Determination of the Microstructure of the Elastomers:

The microstructure of the elastomers is determined by ¹H NMR analysis, compensated for by the ¹³C NMR analysis when the resolution of the ¹H NMR spectra does not make it possible to assign and quantify all the entities. The measurements are performed using a Brüker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra of sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adjusted by a person skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

II.1-2 Determination of the Mooney Viscosity:

The Mooney viscosity is measured using an oscillating consistometer as described in Standard ASTM D1646 (1999). The measurement is carried out according to the following principle: the sample, analysed in the uncured state (i.e. before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity is expressed in “Mooney unit” (MU, with 1 MU=0.83 newton·metre).

II.1-3 Dynamic Properties:

The dynamic properties are measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99, is recorded. A strain amplitude sweep is carried out from 0.1% to 50% (outward cycle) and then from 50% to 0.1% (return cycle). The results made use of are the complex shear modulus G* at 10% and the loss factor tan(δ). The maximum value of tan(δ) observed, denoted tan(δ)max, and also the value of G* at 10%, are shown for the return cycle.

The response of a sample of vulcanized composition subjected to a sinusoidal simple alternating shear stress at an imposed stress of 0.7 MPa and at a frequency of 10 Hz, during a temperature sweep, at a minimum temperature of less than the Tg of the elastomers of the compositions up to a maximum temperature greater than 100° C. is also recorded; the values of G* are taken at the temperature of 60° C.

II.2 Preparation of the Rubber Compositions:

Seven rubber compositions C1 to C7, the formulation details of which appear in Table 1, were prepared as follows:

The elastomers, the reinforcing filler and the various other ingredients, with the exception of the sulfur and the vulcanization accelerator, are successively introduced into an internal mixer (final degree of filling: approximately 70% by volume), the initial vessel temperature of which is about 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being mixed (productive phase) for an appropriate time (for example approximately ten minutes).

The compositions thus obtained are then calendered either in the form of slabs (thickness 2 to 3 mm) or of thin sheets of rubber for the measurement of their physical or mechanical properties, or extruded to form for example a profiled element for a tire.

The seven rubber compositions C1 to C7 all contain a copolymer of ethylene and of 1,3-butadiene in which the content of ethylene units is greater than 50%. In the compositions C5 to C7, the copolymer bears a silanol or alkoxysilane function at the chain end.

The copolymer of ethylene and of 1,3-butadiene (EBR) is prepared according to the following procedure:

The cocatalyst, the butyloctylmagnesium (BOMAG) (0.00021 mol/l) and then the metallocene [{Me₂SiFlu₂Nd(μ-BH₄)₂Li(THF)}₂] (0.07 mol/l) are added to a reactor containing methylcyclohexane, the Flu symbol representing the C₁₃H₈ group. The alkylation time is 10 minutes, the reaction temperature is 20° C. Then, the monomers in the form of a gas mixture of ethylene/1,3-butadiene molar composition: 80/20 are added continuously. The polymerization is carried out under conditions of constant temperature and pressure of 80° C. and 8 bar. The polymerization reaction is stopped by cooling, degassing of the reactor and addition of ethanol. An antioxidant is added to the polymer solution. The copolymer is recovered by drying in an oven under vacuum to constant weight.

In the EBR copolymer, the molar content of ethylene units is 79%, the molar content of 1,4 units is 6%, the molar content of 1,2 units is 8%, and the molar content of 1,2-cyclohexanediyl units is 7%. The Mooney viscosity is 85.

For the EBR-F copolymer used in the rubber composition C5 to C7, the copolymer is prepared according to the same procedure as the EBR copolymer, except for the following difference:

When the desired monomer conversion is achieved, the content of the reactor is degassed and then the functionalizing agent, (N,N-dimethyl-3-aminopropyl)methyldimethoxysilane, is introduced under an inert atmosphere by excess pressure. The reaction medium is stirred for a time of 15 minutes and a temperature of 80° C. After reaction, the medium is degassed and then precipitated from methanol. The polymers are redissolved in toluene, then precipitated from methanol so as to eliminate the ungrafted “silane” molecules, which makes it possible to improve the quality of the signals of the spectra for the quantification of the function content and the integration of the various signals. The polymer is treated with antioxidant then dried at 60° C. under vacuum to constant weight.

In the EBR-F copolymer, the molar content of ethylene units is 76%, the molar content of 1,4 units is 6%, the molar content of 1,2 units is 9%, and the molar content of 1,2-cyclohexanediyl units is 9%. The Mooney viscosity is 84.

TABLE 1

| Composition | C1 | C2 | C3 | C4 | C5 | C6 | C7 |
|---|---|---|---|---|---|---|---|
| EBR | 100 | 100 | 100 | 100 | | | |
| EBR-F | | | | | 100 | 100 | 100 |
| Carbon black (1) | 3 | 3 | 3 | 3 | 3 | 3 | 3 |
| Silica (2) | 75 | 91 | 83 | 63 | 63 | 75 | 75 |
| Liquid plasticizing | 38 | 26 | 20 | 10 | 23 | 38 | 22 |
| agent (3) | | | | | | | |
| Plasticizing resin (4) | 32 | 31 | 23 | 25 | 23 | 32 | 51 |
| Antioxidant (5) | 2 | 2 | 2 | 2 | 2 | 2 | 2 |
| Anti-ozonant wax | 1.6 | 1.6 | 1.6 | 1.6 | 1.6 | 1.6 | 1.6 |
| Coupling agent (6) | 6 | 7 | 7 | 5 | 5 | 6 | 6 |
| Stearic acid (7) | 2 | 2 | 2 | 2 | 2 | 2 | 2 |
| DPG (8) | 1.5 | 1.8 | 1.5 | 1.2 | 1.2 | 1.5 | 1.5 |
| ZnO (9) | 1 | 1 | 1 | 1 | 1 | 1 | 1 |
| CBS (10) | 2 | 2 | 2 | 2 | | 2 | 2 |
| Sulfur | 1 | 1 | 1 | 1 | 1.6 | 1 | 1 |
| TBzTD (11) | | | | | 2 | | |
| Ratio (12) | 1.1 | 1.6 | 2.0 | 1.9 | 1.4 | 1.1 | 1.0 |
| Ratio (13) | 0.46 | 0.54 | 0.53 | 0.71 | 0.50 | 0.46 | 0.67 |
| Tan(δ)max 23° C. | 0.31 | 0.40 | 0.38 | 0.29 | 0.18 | 0.25 | 0.30 |
| G* 10%, 23° C. (MPa) | 2.5 | 3.7 | 4.6 | 3.2 | 1.9 | 1.9 | 2.0 |
| G* 60° C. 0.7 MPa | 1.2 | 1.7 | 2.4 | 1.7 | 1.3 | 1 | 1 |
| (MPa) | | | | | | | |

(1) N234
(2) Zeosil 1165 MP, from Solvay-Rhodia, in the form of microbeads
(3) MES/HPD (Catenex SNR from Shell)
(4) Escorez 5600 C9/Dicyclopentadiene hydrocarbon resin from Exxon (Tg = 55° C.)
(5) N-(1,3-Dimethylbutyl)-N-phenyl-para-phenylenediamine (Santoflex 6-PPD from Flexsys)
(6) TESPT (Si69 from Evonik)
(7) Stearin, Pristerene 4931 from Uniquema
(8) Diphenylguanidine
(9) Zinc oxide, industrial grade from Umicore
(10) N-Cyclohexy1-2-benzothiazolesulfenamide (Santocure CBS from Flexsys)
(11) Tetrabenzylthiuram disulfide (Perkacit TBZTD from Flexsys)
(12) Weight ratio between the content of reinforcing filler and the total content of hydrocarbon plasticizing resin and of hydrocarbon liquid plasticizing agent
(13) Weight ratio between the content of hydrocarbon plasticizing resin and the total content of hydrocarbon plasticizing resin and of hydrocarbon liquid plasticizing agent.
(1)

1. A rubber composition which comprises:
an elastomer which is a copolymer of ethylene and of a 1,3-diene which comprises ethylene units which represent more than 50 mol % of the monomer units of the copolymer, the 1,3-diene being 1,3-butadiene or isoprene,
35 to 100 phr of a reinforcing filler which comprises a silica,
a plasticizing system comprising a hydrocarbon plasticizing resin and a liquid hydrocarbon plasticizing agent, wherein the total content of the hydrocarbon plasticizing resin and of the liquid hydrocarbon plasticizing agent is greater than 10 phr and less than or equal to 80 phr.

2. The rubber composition according to claim 1, in which the ethylene units in the copolymer represent more than 60 mol % of the monomer units of the copolymer.

3. The rubber composition according to claim 1, in which the copolymer contains units of formula (I) or units of formula (II-1) or (II-2) or else contains units of formula (I) and of formula (II-1)

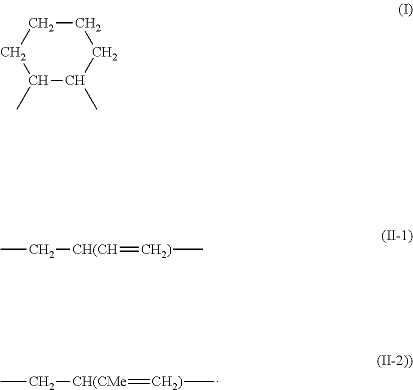

4. The rubber composition according to claim 3, in which the molar percentages of the units of formula (I) and of the units of formula (II-1) in the copolymer, respectively o and p, satisfy the following equation (eq. 1), o and p being calculated on the basis of all the monomer units of the copolymer
0<o+p≤25 (eq. 1),

5. The rubber composition according to claim 1, in which the copolymer is a random copolymer.

6. The rubber composition according to claim 1, in which the copolymer of ethylene and of a 1,3-diene bears at the chain end a functional group F¹ which is a silanol or alkoxysilane function.

7. The rubber composition according to claim 1, in which the content of the copolymer of ethylene and of a 1,3-diene is greater than 50 phr.

8. The rubber composition according to claim 1, in which the silica represents more than 50% by weight of the reinforcing filler.

9. The rubber composition according to claim 1, in which the hydrocarbon plasticizing resin has a glass transition temperature of greater than 20° C.

10. The rubber composition according to claim 1, in which the hydrocarbon plasticizing resin is selected from the group consisting of cyclopentadiene homopolymer resins, cyclopentadiene copolymer resins, dicyclopentadiene homopolymer resins, dicyclopentadiene copolymer resins, terpene homopolymer resins, terpene copolymer resins, C5-cut homopolymer resins, C5-cut copolymer resins, C9-cut homopolymer resins, C9-cut copolymer resins, hydrogenated cyclopentadiene homopolymer resins and hydrogenated cyclopentadiene copolymer resins.

11. The rubber composition according to claim 1, in which the hydrocarbon liquid plasticizing agent is selected from the group consisting of liquid diene polymers, aliphatic polyolefin oils, paraffinic oils, MES oils, TDAE oils, RAE oils, TRAE oils, SRAE oils, mineral oils and mixtures thereof.

12. The rubber composition according to claim 1, in which the weight ratio between the content of hydrocarbon plasticizing resin and the total content of hydrocarbon plasticizing resin and of hydrocarbon liquid plasticizing agent is greater than 0.4.

13. The rubber composition according to claim 1, in which the weight ratio between the content of reinforcing filler and the total content of hydrocarbon plasticizing resin and of hydrocarbon liquid plasticizing agent is less than 1.2.

14. The rubber composition according to claim 1, in which the weight ratio between the content of reinforcing filler and the total content of hydrocarbon plasticizing resin and of hydrocarbon liquid plasticizing agent is greater than or equal to 1.2.

15. A tire comprising: a crown extended by two sidewalls and two beads, a carcass reinforcement anchored in the two beads, a crown reinforcement and a tread radially outside said crown reinforcement, which tire comprises a rubber composition defined in claim 1 in the tread.

16. The rubber composition according to claim 2, in which the ethylene units in the copolymer represent more than 70 mol % of the monomer units of the copolymer.

17. The rubber composition according to claim 3, in which the molar percentages of the units of formula (I) and of the units of formula (II-1) in the copolymer, respectively o and p, satisfy the following equation (eq. 2)
0<o+p<20 (eq. 2).

18. The rubber composition according to claim 7, in which the content of the copolymer of ethylene and of a 1,3-diene is greater than 80 phr.

19. The rubber composition according to claim 8, in which the silica represents more than 85% by weight of the reinforcing filler.

20. The rubber composition according to claim 10, in which the hydrocarbon plasticizing resin is selected from the group consisting of a C9-cut copolymer resin or a dicyclopentadiene copolymer resin, which is hydrogenated or non-hydrogenated.
